(19) United States
(12) Patent Application Publication
(10) Pub. No.: US 2024/0172891 A1
(43) Pub. Date: May 30, 2024

(54) METHODS AND APPARATUS FOR HIGH-HEAT COOKING

(71) Applicant: Electrolux Home Products, Inc., Charlotte, NC (US)

(72) Inventors: Devin Hooie, Hendersonville, TN (US); Michael D. Padgett, Springfield, TN (US); Andre Garcia, Hendersonville, TN (US); Tyler Adcock, Springfield, TN (US)

(21) Appl. No.: 18/524,560

(22) Filed: Nov. 30, 2023

Related U.S. Application Data
(60) Provisional application No. 63/428,792, filed on Nov. 30, 2022.

(51) Int. Cl. A47J 37/06; A23L 5/10; A47J 36/04; A47J 36/34; A47J 37/01

(52) U.S. Cl. CPC A47J 37/0694; A23L 5/15; A47J 36/04; A47J 36/34; A47J 37/01

(57) ABSTRACT

A rack assembly is mountable within an oven cavity of a cooking appliance. The rack assembly includes a cooking stone; an insulating mat defining a recess configured to accommodate the cooking stone; and a rack configured to support the insulating mat. A superficial area of the insulating mat is at least 70% of a superficial area of the rack.

### CROSS-REFERENCE TO RELATED APPLICATIONS

This application claims the benefit of U.S. provisional application Ser. No. 63/428,792 filed Nov. 30, 2022, the contents of which are incorporated by reference.

### TECHNICAL FIELD

The present disclosure relates to methods and apparatus for high-heat cooking in an oven cavity of a cooking appliance and, more particularly, high-heat cooking in a confined portion of the oven cavity.

### BACKGROUND

Domestic cooking appliances can include an oven cavity and one or more preprogrammed cooking operations for cooking food in the oven cavity. The maximum temperature setting for any cooking operation of a domestic appliance is typically about 550° F., because safety regulations require the oven door to automatically lock once the oven cavity reaches a temperature of about 600° F. However, various cooking operations may benefit from higher cooking temperatures. For example, in conventional methods of cooking pizza, a ceramic cooking stone is placed on a rack in the oven cavity, and a baking operation is performed to heat the oven cavity and cooking stone to a selected cooking temperature. The ideal cooking temperature of the cooking stone for brick-oven style pizza is preferably about 750° F. Thus, a conventional baking operation, even at its highest temperature setting, cannot heat the cooking stone up to its ideal cooking temperature.

### BRIEF SUMMARY

According to a first aspect, a rack assembly is mountable within an oven cavity of a cooking appliance. The rack assembly includes a cooking stone; an insulating mat defining a recess configured to accommodate the cooking stone; and a rack configured to support the insulating mat. A superficial area of the insulating mat is at least 70% of a superficial area of the rack.

According to a second aspect, a cooking appliance includes a oven cavity, a broil element adjacent to an upper wall of the oven cavity, a rack within the oven cavity, and a cooking stone supported by the rack. A cooking operation for the cooking appliance includes a preheat stage during which the broil element is operated according to a preheat-power scheme in order to heat the cooking stone and air within the oven cavity; a reduced-power stage during which the broil element is operated according to a reduced-power scheme in order to reduce a heat output of the broil element while the cooking stone emits residual heat; and an increased-power stage during which the broil element is operated according to an increased-power scheme. The reduced-power scheme operates the broil element at less power than the preheat-power scheme, and the increased-power scheme operates the broil element at greater power than the reduced-power scheme.

### BRIEF DESCRIPTION OF THE DRAWINGS

FIG. 1 is a schematic side view, in cross-section, of an example cooking appliance;

FIG. 2 shows a front-perspective view of a cooking compartment of the cooking appliance;

FIG. 3 shows a perspective view of a first rack assembly for the cooking appliance;

FIG. 4 shows an exploded, perspective view of a cooking stone and an insulating mat of the first rack assembly;

FIG. 5 shows a perspective view of a rack of the first rack assembly;

FIG. 6 shows a perspective view of a second rack assembly for the cooking appliance;

FIG. 7 shows an insulating mat of the second rack assembly;

FIG. 8 shows a rack of the second rack assembly;

FIG. 9 shows a cross-section view of the cooking appliance with the second rack assembly mounted in an oven cavity of the appliance;

FIG. 10 shows a first cooking operation for the cooking appliance;

FIG. 11 shows various details for a rack detection stage and a preheat stage of the first cooking operation;

FIG. 12 shows various details for an intermediate stage of the first cooking operation;

FIG. 13 shows various details for a reduced-power stage of the first cooking operation;

FIG. 14 shows various details for an increased-power stage of the first cooking operation;

FIG. 15 shows a second cooking operation for the cooking appliance;

FIG. 16 shows various details for a rack detection stage and a preheat stage of the second cooking operation;

FIG. 17 shows various details for first reduced-power stage of the second cooking operation;

FIG. 18 shows various details for an intermediate stage of the second cooking operation;

FIG. 19 shows various details for a recovery stage of the second cooking operation;

FIG. 20 shows various details for a second reduced-power stage of the second cooking operation;

FIG. 21 shows various details for an increased-power stage of the second cooking operation; and

FIG. 22 shows a third cooking operation for the cooking appliance.

### DETAILED DESCRIPTION

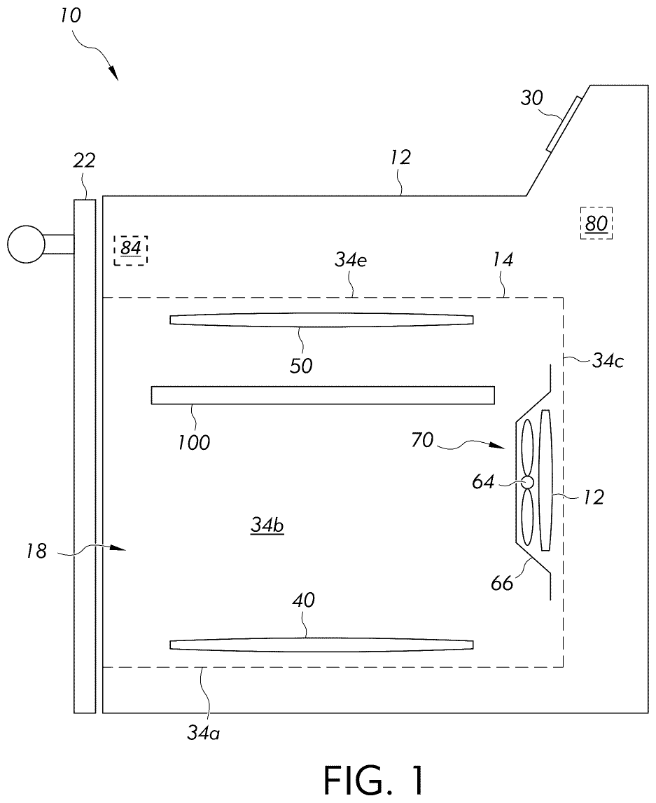

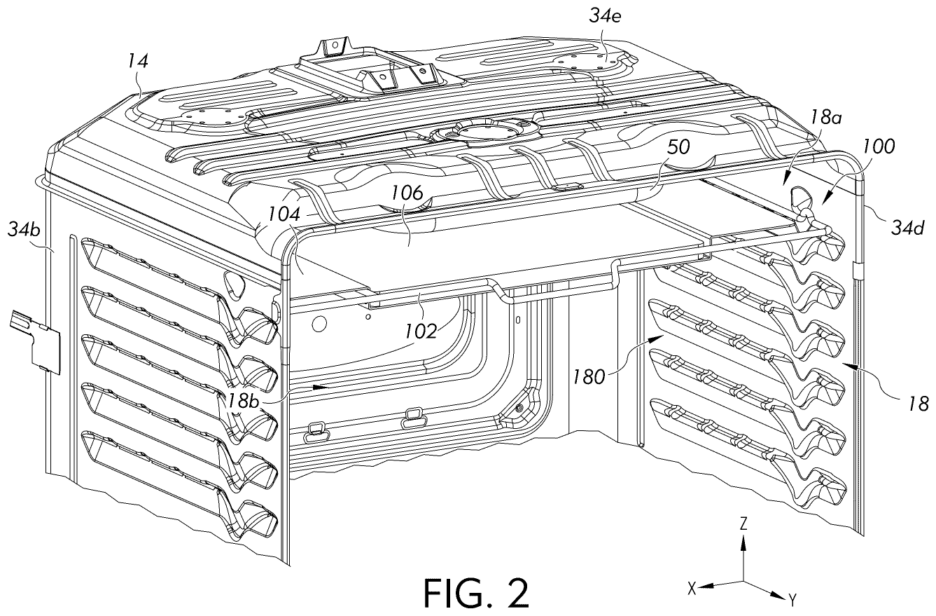

Turning to FIG. 1, an example cooking appliance 10 is illustrated having a housing 12, a cooking compartment 14 that defines a cavity 18, a door 22 pivotally attached to the housing 12 that provides selective access to the cavity 18, and a control panel having a user interface 30. The compartment 14 has a plurality of walls 34 that define the cavity 18, including a lower wall 34a, a left-side wall 34b, a rear wall 34c, a right-side wall 34d (see FIG. 2) opposite to the left side wall 34b, and an upper wall 34e. Moreover, the left- and right-side walls 34b, 34d of the compartment 14 include multiple opposing pairs of rack supports 38 that are vertically spaced and can receive a rack assembly for supporting food items within the cavity 18.

The appliance 10 further includes a plurality of heating elements 40, 50, 60 that are spaced about the cavity 18 and can be operated to heat the cavity 18 to perform various cooking operations. For example, the appliance 10 includes a lower heating element 40 (“bake element”) arranged at or adjacent to the lower wall 34a of the compartment 14, and which can be operated to perform a baking operation. An upper heating element 50 (“broil element”) can be arranged at or adjacent to the upper wall 34e of the compartment 14, and can be operated to perform a broiling operation. And a rear heating element 60 (“convection element”) can be arranged at or adjacent to the rear wall 34c of the compartment 14, and can be operated with a convection fan 64 to perform a convection cooking operation. The rear element 60 (sometimes referred to as a convection element) and the convection fan 64 typically are covered by a protective shroud 66, and collectively form a convection system 70 of the appliance 10.

Each heating element 40, 50, 60 may be an electric-resistive body (e.g., coil) that converts electrical energy supplied thereto into heat, or a gas burner that burns gas supplied thereto to generate heat. Moreover, each heating element 40, 50, 60 may be located within or outside of the cavity 18, adjacent to its associated compartment wall 34. Still further, the appliance 10 may comprise additional or fewer heating heater elements in other examples. Broadly speaking, the appliance 10 can include any configuration of one or more heating elements that includes a broil element 50 arranged at or adjacent to the upper wall 34e.

The appliance 10 further includes a controller 80 (e.g., programmable logic controller) having a processor and memory, which is operatively coupled (e.g., via one or more wires, relays, digital gas valves, etc.) to the heating elements 40, 50, 60 such that the controller 80 can selectively and independently operate the heating elements 40, 50, 60 to perform various cooking operations. Moreover, the controller 80 is in communication with the user interface 30, which has one or more input elements (e.g., switches, buttons, touchscreens, etc.) that a user can manipulate to provide one or more inputs (e.g., program selections, start commands, temperature settings, etc.) to the controller 80. The user interface 30 also has one or more output elements (e.g., speakers, displays, lights, etc.) that can provide one or more outputs (e.g., program selection screens, cooking operation settings and statuses, sounds, lights, etc.) to convey information to the user.

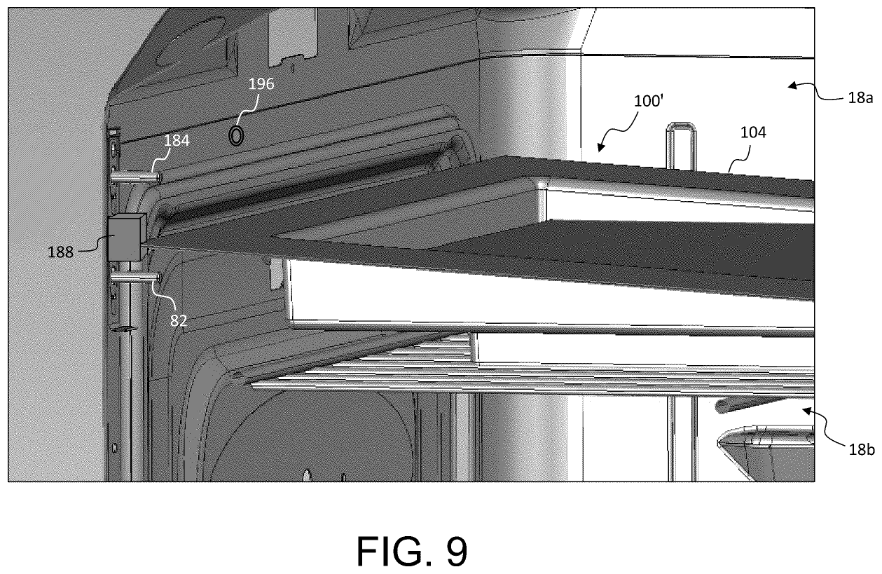

The appliance 10 also includes a primary temperature sensor 82 (see FIG. 9) that is configured to measure temperature and provide an output to the controller 80 indicative of the measured temperature. The sensor 82 is used for controlling basic cooking operations and ensuring that the appliance 10 is in compliance with agency safety regulations. For example, the controller 80 may be configured to perform one or more cooking operations (e.g., baking, convection baking, etc.) based on feedback from the sensor 82. Moreover, per industry regulations, the controller 80 can be configured to automatically lock the oven door 22 if a temperature measured by the sensor 82 exceeds a predetermined threshold (e.g., 600° F.) during any operation of the appliance 10.

Lastly, the appliance 10 includes a door sensor 84 (see FIG. 1) that is configured to detect a position of the door 22 and provide an output to the controller 80 indicative of the detected position. For example, if the door 22 is in a closed position, the door sensor 84 can provide a positive signal to the controller 80 indicating that the door 22 is closed. Conversely, if the door 22 in an open position, the door sensor 84 can provide a zero signal to the controller 80 indicating that the door 22 is open.

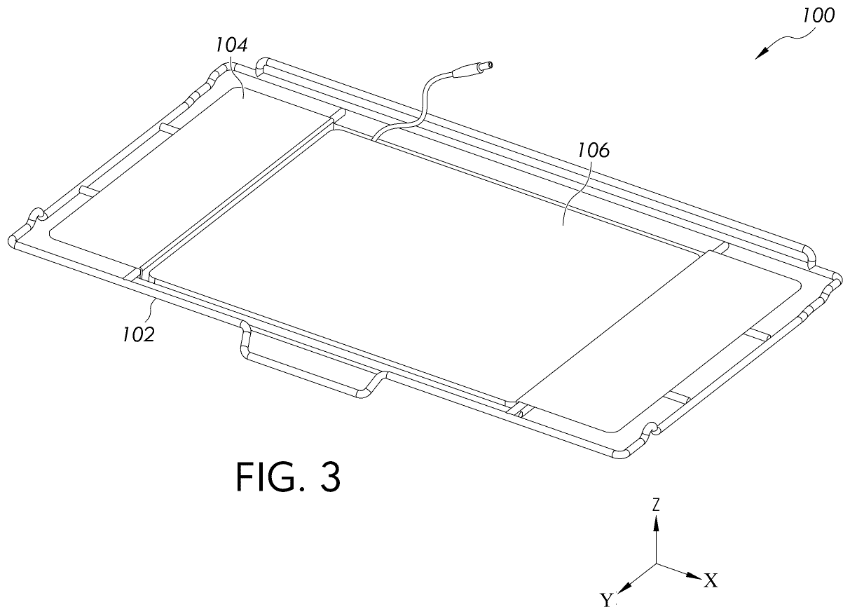

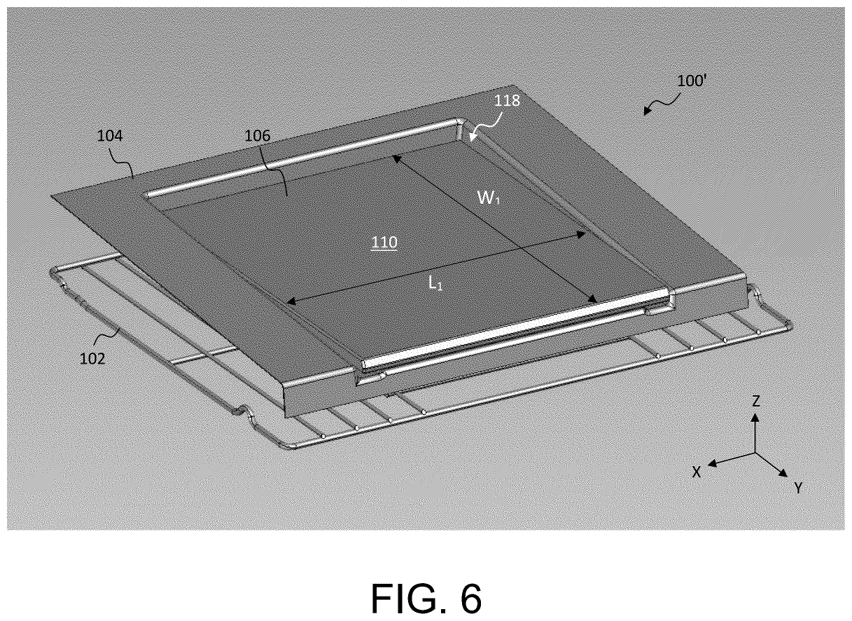

Various example rack assemblies will now be described, which can be mounted within the cavity 18 to support food items for cooking. FIGS. 2-5 show a first example rack assembly 100, while FIGS. 6-8 show a second example rack assembly 100′. As discussed further below, either one of the rack assemblies 100, 100′ can be mounted within the cavity 18 in close proximity to the broil element 50, and is configured to partition and insulate an upper portion 18a of the cavity 18 from a lower portion 18b where the temperature sensor 82 is located. As such, the broil element 50 can be used to cook food within the upper portion 18a at high temperature (e.g., 750° F.) without heating the lower portion 18b up to a temperature that exceeds safety regulations and causes the oven door 22 to automatically lock.

Each rack assembly 100, 100′ is arranged relative to a set of axes X, Y, Z and includes a rack 102, an insulating mat 104, and a ceramic cooking stone 106. The first and second axes X, Y are horizontal and perpendicular to each other, while the third axis Z is vertical and perpendicular to the first and second axes X, Y. Left and right directions of the rack assemblies 100, 100′ extend along the first axis X, while frontward and rearward directions of the rack assemblies 100, 100′ extend along the second axis Y (and thus perpendicular to the left and right directions). As discussed further below, the components of the rack assemblies 100, 100′ have various lengths and widths that are measured along the first and second axes X, Y, respectively.

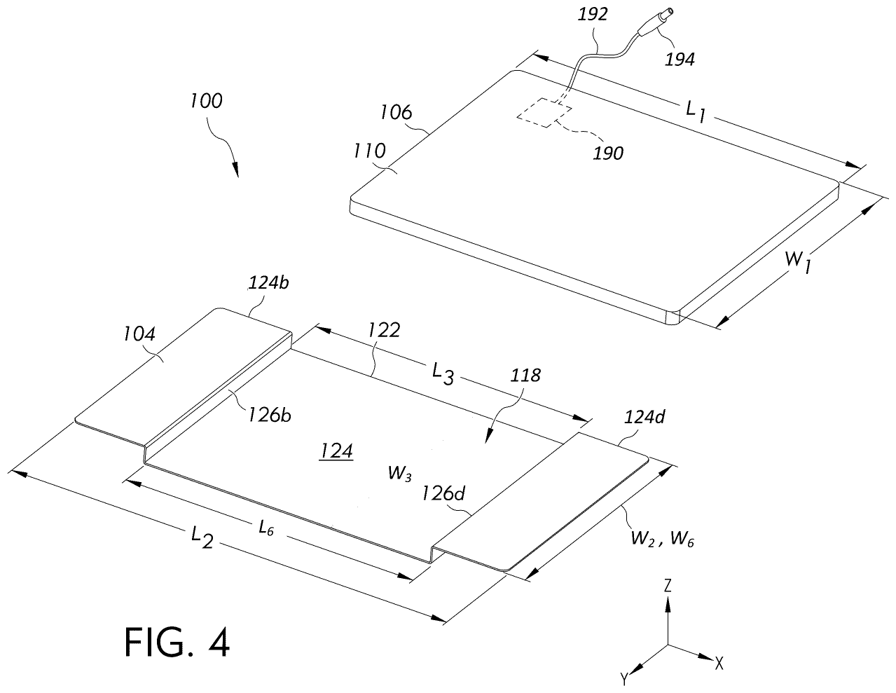

As shown in FIGS. 4 and 6, the cooking stone 106 of each rack assembly 100, 100′ comprises a monolithic body 110 of material such as, for example, ceramic, clay, cordierite, or cast iron. The body 110 in each rack assembly 100, 100′ is a rectangular-shaped body having a length L₁ and width W₁. However, other shapes are possible such as, for example, square or circular.

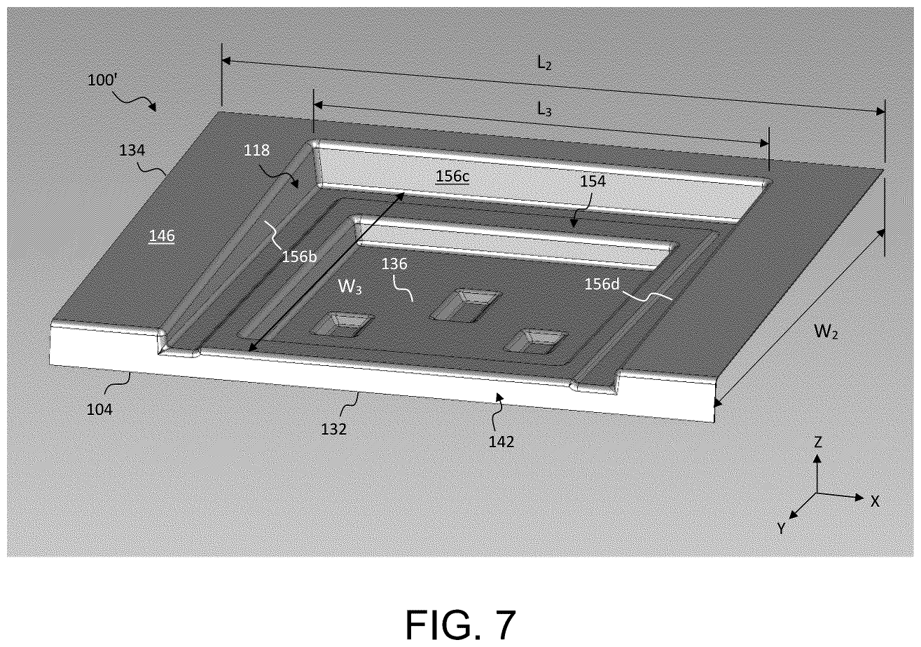

As shown in FIGS. 4 and 7, the insulating mat 104 of each rack assembly 100, 100′ is a generally rectangular body having an overall length L₂ and width W₂. Moreover, the insulating mat 104 defines a recess 118 that is configured to accommodate the cooking stone 106 therein in the assembled rack assembly 100, 100′. In the first rack assembly 100 (see FIG. 4), the insulating mat 104 comprises a single metal sheet that is bent to form a receiving portion 122 and flanges 124b, 124d extending laterally from opposite sides of the receiving portion 122. The receiving portion 122 has a bottom wall 124 and left- and right-side walls 126b, 126d that extend upward from opposites sides of the bottom wall 124, substantially perpendicular to the bottom wall 124. The walls 124, 126b, 126d of the receiving portion 122 define the recess 118, and the left and right flanges 132b, 132d extend outward from the left- and right-side walls 126b, 126d, substantially parallel to the bottom wall 124.

In the second rack assembly 100′ (see FIG. 7), the insulating mat 104 comprises a single metal sheet that is stamped to form a rectangular body having a front panel 132, an upper panel 134, and a receiving portion 136 that defines the recess 118. The front panel 132 has a front surface 142 that extends along a vertical plane that is parallel to or encompasses the first and third axes X, Z. Meanwhile, the upper panel 134 has an upper surface 146 that is sloped in the frontward and rearward directions. Specifically, the upper surface 146 is sloped such that a rear end of the upper surface 146 is elevated relative to a front end of the upper surface 146. The receiving portion 136 includes a bottom wall 154 that extends along a horizontal plane that is parallel to or encompasses the first and second axes X, Y. Moreover, the receiving portion 136 includes left-, rear-, and right-side walls 156b, 156c, 156d that extend upward from a perimeter of the bottom wall 154, substantially perpendicular to the bottom wall 154.

For each rack assembly 100, 100′, the recess 118 of the insulating mat 104 has dimensions that approximate the dimensions of the cooking stone 106, such that the stone 106 will fit securely in the recess 118 when mounted. For example, the recess 118 each rack assembly 100, 100′ has a substantially complementary shape compared to the cooking stone 106, and has a length L₃ and width W₃ that approximate a length L₁ and width W₁ of the stone 106, respectively (for the purposes of this disclosure, a first dimension can “approximate” a second dimension if the ratio between the first and second dimensions (or its inverse) is between 0.85 and 1.0, preferably between 0.90 and 1.0). The cooking stone 106 can be placed within the recess 118 of the insulating mat 104 and supported by its bottom wall 124, 154.

As assembled, the cooking stone 106 will be substantially in-register with the bottom wall 124, 154 of insulating mat 104, fitted snugly (but not necessarily with interference) between the left- and right-side walls 126b, 126d, 156b, 156d. In particular, the left- and right-side walls 126b, 126d, 156b, 156d of the insulating mat 104 can inhibit lateral movement of the cooking stone 106 relative to the insulating mat 104 in left and right directions, respectively. Moreover, the rear-side wall 156c of the insulating mat 104 in the second rack assembly 100′ can restrict rearward movement of the cooking stone 106 relative to the insulating mat 104.

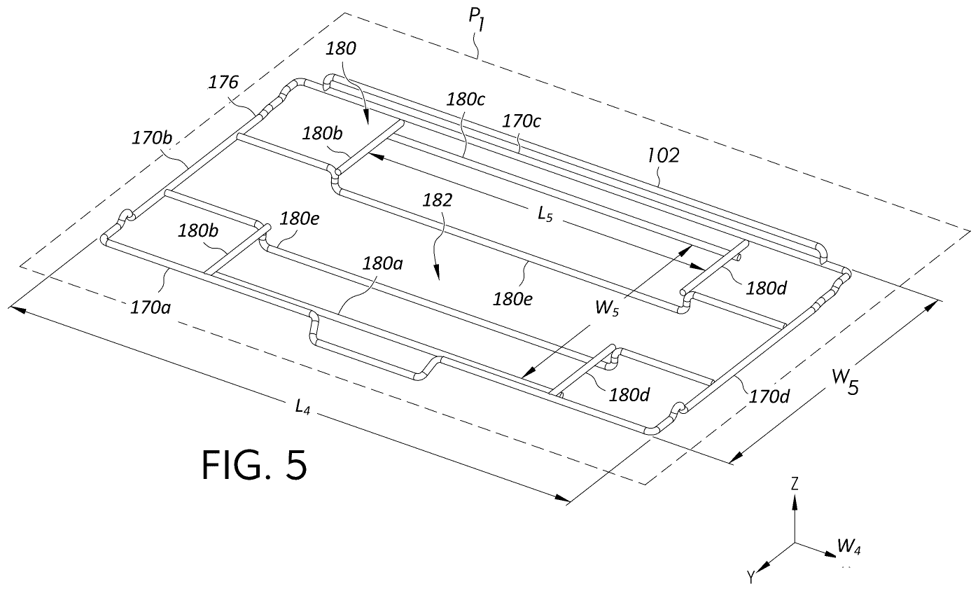

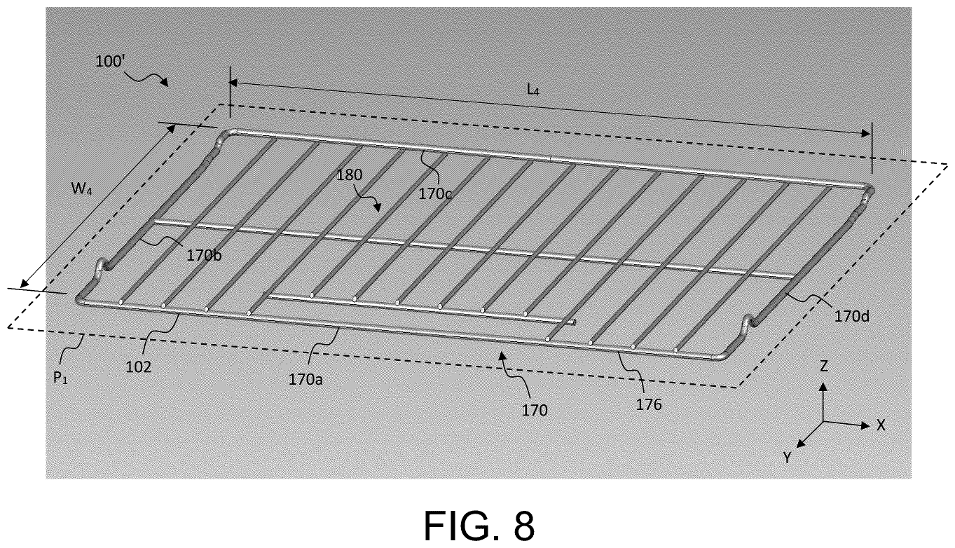

The rack 102 for each assembly 100, 100′ (see FIGS. 5 and 8) is defined by a plurality of metal wires 170, which includes a front wire 170a, a left wire 170b, a rear wire 170c, and a right wire 170d that extend within a primary plane Pi and collectively form a rectangular, outer frame 176 having a length L₄ and a width W₄. The wires 170 further include a plurality of crosswires 180 that are supported by the outer frame 176 and extend horizontally along the rack 102.

The rack 102 of the first assembly 100 (see FIG. 5) has a plurality of crosswires 180b, 180d that extend within the primary plane Pi and define a well 182 configured to accommodate the receiving portion 122 of the insulating mat 104 therein. Moreover, the rack 102 includes a plurality of crosswires 180e that are recessed from the primary plane Pi and define a base of the well 182 in order to support the receiving portion 122 of the insulating mat 104 when seated therein. The well 182 preferably has dimensions that approximate the dimensions of the receiving portion 122 of the insulating mat 104 and cooking stone 106 such that they fit securely in the well 182 when mounted. For example, the well 182 in the illustrated embodiment has a length L₅ that approximates the lengths L₆, L₁ of the receiving portion 122 and the cooking stone 106, and a width W₅ that similarly approximates the widths W₆, W₁ of the receiving portion 122 and the cooking stone 106. This ensures a snug (though not necessarily with interference) fit.

Thus, the cooking stone 106 of the first assembly 100 can be seated within the receiving portion 122 of the insulating mat 104, which in-turn can be seated within the well 182 of the rack 102 such that the bottom wall 124 of the receiving portion 122 rests on the central crosswires 180e, and the left and right flanges 132b, 132d of the insulating mat 104 rest on the left- and right-crosswires 180b, 180d of the rack 102, respectively. The crosswires 180b, 180d, 180e will thus support the insulating mat 104 and cooking stone 106.

The rack 102 of the second assembly 100′ (see FIG. 8), on the other hand, does not include any well. Instead, the crosswires 180 of that rack 102 all extend along the primary plane Pi and define a planar support platform for the insulating mat 104. Thus, the cooking stone 106 of the second assembly 100′ can be seated within the receiving portion 136 of the insulating mat 104, which in-turn can be placed on the crosswires 180 of the rack 102. Notably, the insulating mat 104 of the second assembly 100′ is configured to elevate the cooking stone 106 relative to the rack 102. Specifically, the insulating mat 104 is configured such that in the assembled state of the second rack assembly 100′, the bottom wall 154 of the insulating mat 104 and the cooking stone 106 resting thereon are parallel to and spaced from the primary plane Pi of the rack 102. Preferably, a distance between the bottom wall 154/cooking stone 106 and the primary plane Pi will be 1 to 6 inches, and more preferably 1 to 3 inches. This spacing of the bottom wall 154/cooking stone 106 from the primary plane Pi will elevate the cooking stone 106 relative to the rack 102, thereby positioning the cooking stone 106 closer to the broil element 50 and enabling the broil element 50 to provide more-focused heat to the cooking stone 106 and any food supported thereon.

Each rack assembly 100, 100′ can be mounted in the oven cavity 18 by resting its rack 102 on the rack supports 38 (see FIG. 2) of the compartment's left- and right-side walls 34b, 34d. The rack 102 of each assembly 100, 100′ is preferably a “full width” rack having dimensions that approximate horizontal dimensions of the cavity 12. In particular, the length L₄ of the rack's outer frame 176 can approximate a distance between the left- and right-side walls 34b, 34d. As such, the left- and right-side walls 34b, 34c, 34d of the compartment 14 can restrict lateral movement of the rack 102 when mounted within the cavity 18.

As mounted, the cooking stone 106 preferably will be substantially centered in the rack 102 between the left and right walls 34b, 34d of the compartment 14, such that the cooking stone 106 is directly below the broil element 50. Moreover, lateral movement of the cooking stone 106 can be inhibited by the rack 102 and/or insulating mat 104.

For example, with respect to the first rack assembly 100, the left- and right-crosswires 180b, 180d of the rack 102 (see FIG. 5) can inhibit lateral movement of the insulating mat 104 and cooking stone 106 relative to the rack 102 in left and right directions, respectively. Meanwhile, the front and rear crosswires 180a, 180c of the rack 102 can inhibit lateral movement of the insulating mat 104 and cooking stone 106 relative to the rack 102 in frontward and rearward directions, respectively.

With respect to the second rack assembly 100′, the left-, rear-, and right-side walls 156a, 156b, 156c of the insulating mat 104 can inhibit lateral movement of the cooking stone 106 relative to the mat 104 in left, rear, and right directions, respectively. Moreover, lateral movement of the insulating mat 104 (and cooking stone 106) relative to the rack 102 can be inhibited by friction between the mat 104 and rack 102. In some examples, the insulating mat 104 can have dimensions that approximate horizontal dimensions of the cavity 12, such that lateral movement of the insulating mat 104 is restricted by the left-, rear-, and right-side walls 34a, 34b, 34c of the compartment 14. In particular, the length L₂ of the insulating mat 104 can approximate a distance between the left- and right-side walls 34b, 34d. Moreover, the width W₂ of the insulating mat 104 can approximate a depth of the rear-side wall 34c from the door 22 when closed. Inhibiting lateral movement of the insulating mat 104 and cooking stone 106 can prevent those elements from shifting as food (e.g., pizza, steak, etc.) is slid onto or off of the cooking stone 106 during a cooking operation.

As noted above, each rack assembly 100, 100′ is configured to partition and insulate an upper portion 18a of the cavity 18 from a lower portion 18b where the temperature sensor 82 is located. In particular, the insulating mat 104 of each assembly 100, 100′ can have a superficial area (calculated by multiplying its overall length L₂ and width W₂) that is preferably 80% or more, and more preferably 90% or more, of the rack's superficial area (calculated by multiplying the overall length L₄ and width W₄ of its outer frame 176). Preferably, the overall length L₂ and width W₂ of the insulating mat 104 are approximate to or greater than the respective length L₄ and width W₄ of the rack 102. As such, the insulating mat 104 will occupy a significant proportion of the area defined within the rack's outer frame 176, and by extension of the lateral area of the oven cavity 18 itself, such that the insulating mat 104 partitions and insulates the upper portion 18a from the lower portion 18b.

Moreover, the insulating mat 104 of each rack assembly 100, 100′ is preferably configured such that in the mounted state, the insulating mat 104 will be arranged relative to the primary temperature sensor 82 as shown in FIG. 9. That is, the insulating mat 104 will be arranged in close proximity to and above the sensor 82, such that the mat 104 is arranged directly between the sensor 82 and the broil element 50. Accordingly, the insulating mat 104 can reflect direct radiation travelling downward from the broil element 50 back up toward the upper wall 34e, thereby preventing that direct radiation from entering the lower portion 18b of the cavity 18 and impinging on the sensor 82. This enables the broil element 50 to heat the upper portion 18a to a high temperature (e.g., 750° F.) without heating the sensor 82 and lower portion 18b of the cavity 18 up to a temperature that exceeds safety regulations and causes the oven door 22 to automatically lock.

Various cooking operations are described further below that utilize the broil element 50 and either of the rack assemblies 100, 100′ described above to perform high-heat cooking in the upper portion 18a of the oven cavity 18. In some cases, it may be desirable to control a cooking operation based on temperature of the cooking stone 106 and/or the air within the upper portion 18a. Moreover, it may be desirable to detect a presence of the rack assembly 100, 100′ in order to ensure it is properly mounted prior to and/or during a cooking operation. Accordingly, described below are various features that can facilitate detection of these parameters for regulating one or more cooking operations.

For example, as shown in FIG. 9, the appliance 10 can include an auxiliary temperature sensor 184 that is configured to measure the air temperature within the upper portion 18a and provide an electrical output to controller 80 indicative of its detected temperature.

The appliance 10 can further include a rack detection device 188 (shown schematically in FIG. 9) that is configured to detect the presence of a rack assembly 100, 100′ within the cavity 18 and provide an output to the controller 90 that is indicative of a rack assembly's presence. The rack detection device 188 can be a switch (e.g., tactile switch, limit switch, etc.) that is physically triggered when a rack assembly 100, 100′ is place in or removed from the cavity 18. Alternatively, the rack detection device 188 can be a contactless proximity sensor (e.g., Hall effect sensor, capacitive sensor, optical sensor, etc.) that is configured to a detect a presence of the rack assembly 100, 100′ when in close proximity thereto. The rack detection device 188 can be any device that is operable to provide an output to the controller 80 indicative of a rack assembly's presence.

Moreover, as shown in FIG. 4, the cooking stone 106 of each rack assembly 100, 100′ can include a temperature sensor 190 that is configured to measure a temperature of the body 110 and provide an electrical output indicative of the measured temperature. For instance, the temperature sensor 190 in the present example is embedded within the body 110 such that the sensor is in direct thermal contact with the surrounding body 110. Moreover, the cooking stone 106 includes a cable 192 for establishing an electrical connection between the sensor 190 and another device (e.g., the controller 80). The cable 192 is electrically connected to the sensor 190 at one end and has a connector 194 (e.g., plug) at its other end that can mate with a corresponding connector 196 (see FIG. 9) of the appliance 10 to electrically connect the temperature sensor 190 and controller 80. In this manner, the cable 192 can be plugged into the appliance 10 whenever it is desirable to use the cooking stone 106 and its temperature sensor 190 in a cooking operation, and disconnected from the appliance 10 whenever it is desirable to remove the cooking stone 106 from the appliance 10 (e.g., for cleaning or when not in-use).

In some examples, the connector 196 of the appliance 10 can correspond to the rack detection device 188 described above, since its output to the controller 80 is dependent on connection to (and thus the presence of) the cooking stone 106. That is, the controller 80 can monitor an output from the connector 196 to determine if a rack assembly 100, 100′ is present within the oven cavity 18. If the cooking stone 106 of a rack assembly 100, 100′ is connected to the connector 196, the output of the connector 196 will correspond to the output of the temperature sensor 190, which fluctuates based on temperature of the cooking stone 106. Any positive output from the connector 196 can indicate that the cooking stone 106 is connected to the connector 196, and a rack assembly 100, 100′ is presumably mounted within the cavity 18 in its assembled state. Conversely, a zero output from the connector 196 will indicate that no cooking stone 106 is connected to the connector 196, and presumably neither rack assembly 100, 100′ is present within the cavity 18.

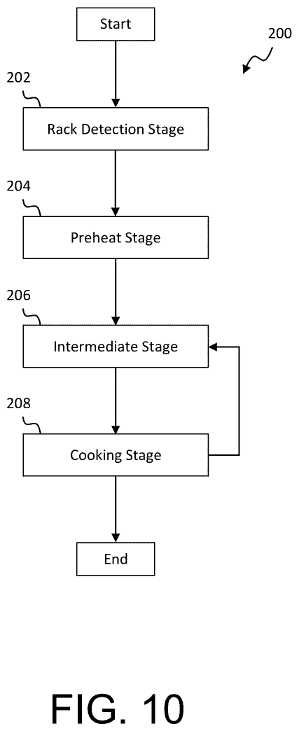

Turning to FIG. 10, a high-heat cooking operation 200 will now be described for cooking food items at high heat using the rack assembly 100, 100′ described above. The cooking operation 200 can be particularly useful for grilling or searing meats (e.g., steak) or cooking “fresh pizza” (pizza with uncooked, non-frozen dough).

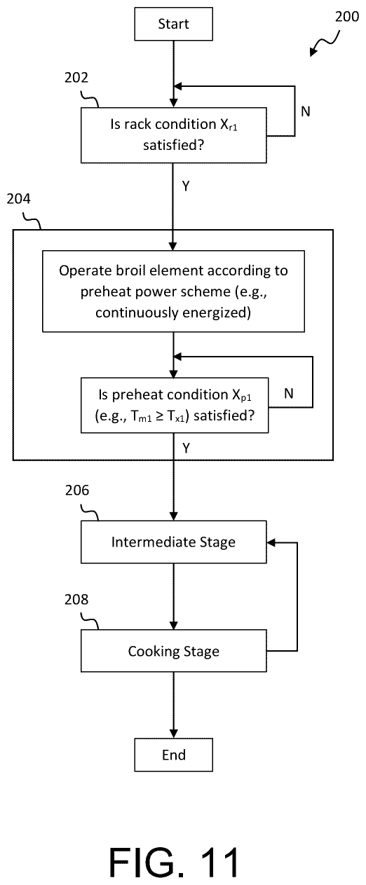

The cooking operation 200 includes a rack detection stage 202, a preheat stage 204, an intermediate stage 206, and a cooking stage 208. The details of these stages 202, 204, 206, 208 are described below and illustrated further in FIGS. 11-14. As discussed further below, the cooking operation 200 will activate only the broil element 50 to heat the oven cavity 18, without activating any other heating element or fan. Moreover, during the cooking operation 200, the rack assembly 100, 100′ will preferably be mounted in the oven cavity 18 close to the broil element 50, such that the cooking stone 106 is spaced about 8 inches or less below the broil element 50, and more preferably 6 inches or less below the broil element 50.

As discussed above, the insulating mat 104 of the rack assembly 100, 100′ will partition and insulate the upper portion 18a of the oven cavity 18 from the lower portion 18b where the temperature sensor 82 is located. The insulating mat 104 can thus reflect direct radiation travelling downward from the broil element 50 back up toward the upper wall 34e, thereby preventing that direct radiation from entering the lower portion 18b of the cavity 18. The result is that the lower portion 18b and primary temperature sensor 82 never reach a temperature (e.g., 600° F.) that would require triggering the door lock as a result of agency regulations.

A user can initiate the first cooking operation 200 by entering a start command on the user interface 30, which in turn will provide a start signal to the controller 80 that causes it to start performing the rack detection stage 202. As shown in FIG. 11, the rack detection stage 202 will monitor the output of the rack detection device 188 to determine if a rack condition Xᵣ₁ is satisfied in which the rack assembly 100, 100′ is present within the oven cavity 18. If the output indicates that the rack condition Xᵣ₁ is satisfied (i.e., the rack assembly 100, 100′ is present), the controller 80 will proceed to and perform the preheat stage 204. Conversely, if the output indicates that the rack condition Xᵣ₁ is not satisfied (i.e., no rack assembly 100, 100′ is present), the controller 80 can either cease the cooking operation 200 or continue monitoring the output until it indicates that a rack assembly 100, 100′ is present.

The controller 80 will perform the preheat stage 204 (see FIG. 11) in response to completion of the rack detection stage 202 (which corresponds to the moment the rack condition Xᵣ₁ is satisfied). Preferably, the preheat stage 204 will be performed without any food being present in the oven cavity 18. During the preheat stage 204, the controller 80 will operate the broil element 50 according to a preheat power scheme until a preheat condition Xₚ₁ is satisfied, at which point the preheat stage 204 will cease and the intermediate stage 206 will begin. For the purposes of this disclosure, a “power scheme” of a heating element can be any scheme that regulates power supplied to the heating element by regulating the rate of energy (e.g., electricity or gas) supplied thereto. For example, power can be regulated (i.e., adjusted or maintained) by continuously energizing the heating element with a constant rate of energy, continuously de-energizing the heating element, varying (e.g., cycling) the rate of energy supplied to heating element, or combinations thereof. The preheat power scheme in the present embodiment continuously energizes the broil element 50 at full power for the entire preheat stage 204 until the preheat condition Xₚ₁ is satisfied.

The preheat condition Xₚ₁ can be any condition that is predetermined to render the oven cavity 18 and/or cooking stone 106 sufficiently preheated for cooking. In particular, the preheat condition Xₚ₁ can be based on a predetermined temperature threshold and/or amount of time. For example, the preheat condition Xₚ₁ in the present embodiment corresponds to a condition in which a temperature Tₘ₁ measured by the sensor 190 of the cooking stone 106 is equal to or greater than a predetermined target temperature Tₓ₁. For cooking fresh pizza, the target temperature Tₓ₁ will preferably be 700° F. or greater, and more preferably 750° F. or greater. In other examples, the preheat condition Xₚ₁ may correspond to a condition in which the broil element 50 has been operated according to the preheat power scheme for a predetermined amount of time (e.g., 20 minutes or more, and more preferably 24 minutes or more) sufficient to heat the cooking stone 106 up to a desirable temperature for the cooking operation.

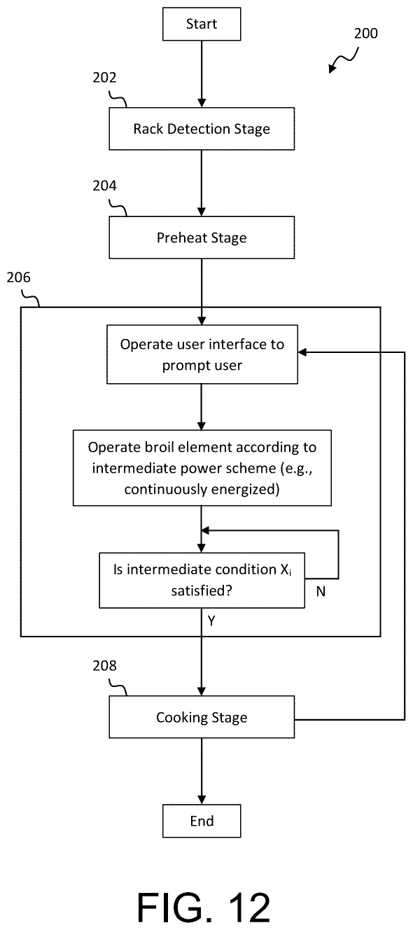

The controller 80 will perform the intermediate stage 206 in response to completion of the preheat stage 204 (which corresponds to the moment the preheat condition Xₚ₁ is satisfied). At the beginning of the intermediate stage 206 (see FIG. 12), the controller 80 will operate the user interface 30 of the cooking appliance 10 to provide an indication that prompts a user to place a food item in the cavity 18. In particular, the controller 80 will provide an electrical signal to the user interface 30, which in turn will provide an output (e.g., light, image, sound, etc.) indicating (e.g., either explicitly or implicitly) that the preheat stage 204 is complete and a food item can be placed in the oven cavity 18.

Moreover, during the intermediate stage 206, the controller 80 will operate the broil element 50 according to an intermediate power scheme in order to keep the upper portion 18a of the oven cavity 18 and the cooking stone 106 heated while the user places a food item on the cooking stone 106 in the oven cavity 18. In particular, the controller 80 will continuously energize the broil element 50 for the entire intermediate stage 206 until an intermediate condition Xᵢ is satisfied, at which point the intermediate stage 206 will cease and the cooking stage 208 will begin.

The intermediate condition Xᵢ can be any predetermined condition indicating or suggesting that food has been placed in the cavity 18 and is ready for the cooking stage 208. For example, when a user opens the door 22 to insert a food item and then subsequently closes the door 22, the door sensor 84 can provide an input signal to the controller 80 indicating that the door 22 has been opened and closed during the intermediate stage 206. That input signal therefore suggests that a food item is in the cavity 18 and ready for cooking. Additionally or alternatively, the user can provide an input to the user interface 30 indicating that a food item is in the cavity 18 and ready for cooking, and the user interface 30 will provide a corresponding input signal to the controller 80 in response to the user input. Thus, the intermediate condition Xᵢ can correspond to a condition in which the controller 80 receives either of those input signals from the door sensor 84 and user interface 30.

The controller 80 will perform the cooking stage 208 in response to completion of the intermediate stage 206 (which corresponds to the moment the intermediate condition Xᵢ is satisfied). As discussed above, the preheat and intermediate stages 204, 206 will operate the broil element 50 according to respective power schemes, thereby heating the cooking stone 106 and the air within the upper portion 18a of the oven cavity 18 up to a high temperature (e.g., 700° F.). However, once a food item is placed on the cooking stone 106 and the cooking stage 208 begins, keeping the broil element 50 energized throughout the entire cooking stage 208 may cause an upper portion of the food item to cook faster than the bottom, since the combination of convective heat from the air and radiative heat from the broil element 50 will be greater than the conductive heat from the cooking stone 106. This may cause the upper and lower portions of the food item to cook differently, resulting in the upper portion being overcooked and/or the lower portion being undercooked.

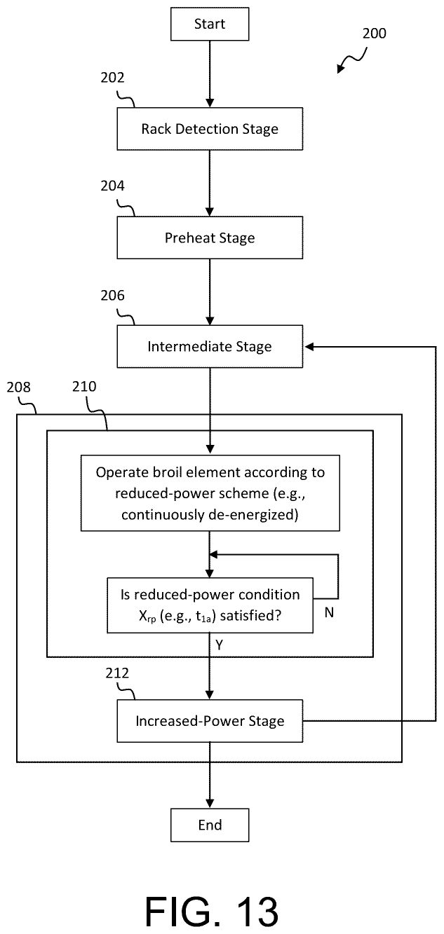

Accordingly, at the beginning of the cooking stage 208, the controller 80 will perform a reduced-power stage 210 (see FIG. 13) that operates the broil element 50 according to a reduced-power scheme in order to reduce air temperature and a heat output of the broil element 50. In particular, the reduced-power scheme will operate the broil element 50 at less power than the preheat- and intermediate-power schemes. For the purposes of this disclosure, a first power scheme can operate a heating element at less power than a second power scheme if the average or maximum power (i.e., rate of energy) supplied to the heating element during the first power scheme is less than the average or maximum power supplied to the heating element during the second power scheme. Conversely, a first power scheme can operate a heating element at greater power than a second power scheme if the average or maximum power supplied to the heating element during the first power scheme is greater than the average or maximum power supplied to the heating element during the second power scheme. For example, in the present embodiment, the preheat- and intermediate-power schemes will continuously energize the broil element 50 at full power, and the reduced-power scheme will continuously de-energize the broil element 50. Thus, the reduced-power scheme will operate the broil element 50 at less power than the preheat- and intermediate-power schemes.

Operating the broil element 50 at the reduced-power scheme (e.g., continuously de-energized) will cause air temperature and the heat output of the broil element 50 to decrease (although the broil element 50 may still provide some heat output if, for example, it has residual heat and/or remains energized at a low level). Meanwhile, the cooking stone 106 will emit residual heat to conductively cook the food item resting thereon. Thus, the reduced-power stage 210 can begin cooking the lower portion of the food item while the cavity air and broil element 50 are providing relatively low heat output to the upper portion of the food item.

The reduced-power stage 210 will operate the broil element 50 according to the reduced-power scheme until a reduced-power condition Xᵣₚ is satisfied, at which point the reduced-power stage 210 will cease and the controller 80 will proceed to an increased-power stage 212. The reduced-power condition Xᵣₚ can be any predetermined condition in which the lower portion of the food item has been at least partially cooked and the upper portion of the food item is ready for additional heat to complete the cooking process. In particular, the reduced-power condition Xᵣₚ can be based on a predetermined temperature threshold and/or amount of time. For example, the reduced-power condition Xᵣₚ in the present embodiment corresponds to a condition in which the broil element 50 has been operated according to the reduced-power scheme for a predetermined amount of time t₁ₐ (e.g., one minute). In other examples, the reduced-power condition X, can correspond to a condition in which a temperature measured by the auxiliary temperature sensor 184 of the appliance 10 is equal to or less than a predetermined target temperature.

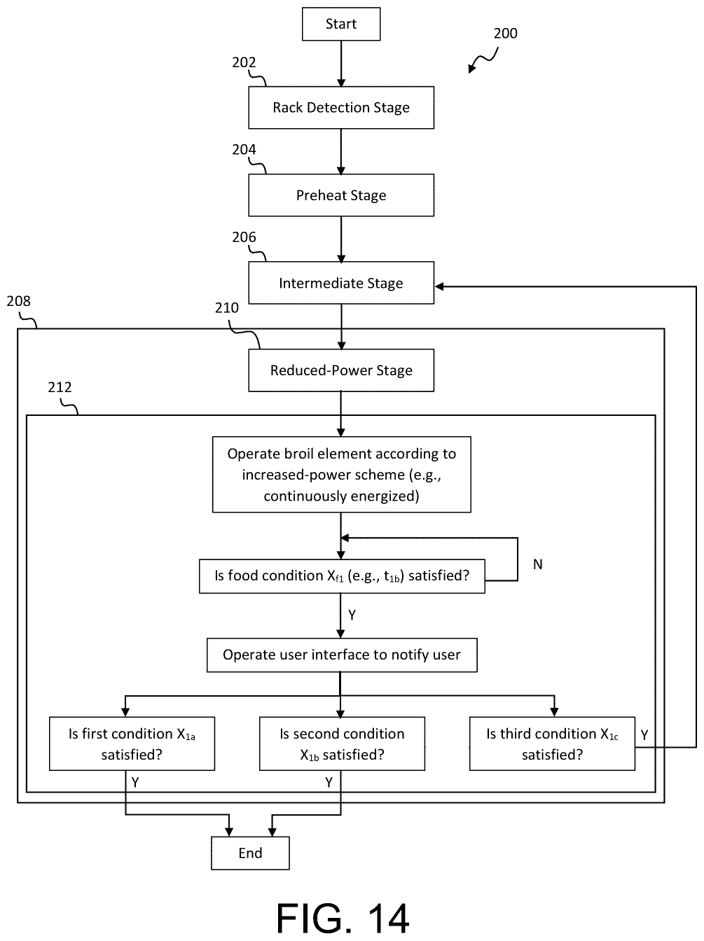

The controller 80 will perform the increased-power stage 212 (see FIG. 14) in response to completion of the reduced-power stage 210 (which corresponds to the moment the reduced-power condition Xᵣₚ is satisfied). In this stage 212, the controller 80 will operate the broil element 50 according to an increased-power scheme in order to increase a heat output of the broil element 50 and finish cooking the food item at high heat. In particular, the increased-power scheme will continuously energize the broil element 50 at full power for the entire increased-power stage 212. Thus, the increased-power scheme will operate the broil element 50 at greater power than the reduced-power scheme.

During the increased-power stage 212, the controller 80 can operate the user interface 30 to provide a notification to the user once the food item is finished cooking. In particular, the controller 80 can determine if a food condition X_{f1} is satisfied indicating or suggesting that the food item is finished cooking. The food condition X_{f1} can be based on a predetermined temperature threshold and/or amount of time. For example, the food condition X_{f1} in the present embodiment corresponds to a condition in which the broil element 50 has been operated according to the increased-power scheme for a predetermined amount of time t_{1b} (e.g., one minute) sufficient to finish cooking the food item. In other examples, the food condition X_{f1} can correspond to a condition in which a temperature measured by a food probe is equal to or greater than a predetermined target temperature. In response to the food condition X_{f1} being satisfied, the controller 80 will provide an electrical signal to the user interface 30, which in turn will provide an output (e.g., light, image, sound, etc.) indicating (e.g., either explicitly or implicitly) that the food item can be removed from the cavity 18.

The increased-power stage 212 will continue operating the broil element 50 according to the increased-power scheme until either one of a first condition X₁ₐ, a second condition X_{1b}, and a third condition X_{1c} is satisfied, at which point the increased-power stage 212 will cease. For example, the first condition X₁ₐ may correspond to a condition in which the controller 80 receives an input signal to cancel the cooking operation 200. More specifically, a user can enter a cancel command on the user interface 30, which in turn will provide a corresponding input signal to the controller 80. If this first condition X₁ₐ is satisfied, the controller 80 will cease the whole cooking operation 200. In other words, the first condition X₁ₐ enables a user to manually end the cooking operation 200.

Meanwhile, the second condition X_{1b} may correspond to a condition in which a predetermined amount of time (e.g., 5 minutes) has lapsed since the food condition X_{f1} was initially satisfied. If that second condition X_{1b} is satisfied, the controller 80 will also cease the whole cooking operation 200. In other words, the second condition X_{1b} enables the controller 80 to automatically cease the cooking operation 200 if no cancel command is provided by the user within the predetermined amount of time.

Lastly, the third condition X_{1c} may correspond to a condition in which the controller 80 receives an input signal to repeat the cooking operation 200. More specifically, if a user wants to cook another food item using the cooking operation 200, the user can enter a repeat command on the user interface 30, which in turn will provide a corresponding input signal to the controller 80. If this third condition X_{1c} is satisfied, the controller 80 will cease the increased-power stage 212 and repeat the intermediate stage 206 in response to completion of the increased-power stage 212. As discussed above, the intermediate stage 206 will operate the broil element 50 according to an intermediate power scheme in order to keep the upper portion 18a of the oven cavity 18 and the cooking stone 106 heated while the user places a food item on the cooking stone 106 in the oven cavity 18. Moreover, intermediate stage 206 will continue to operate the broil element 50 according to the intermediate power scheme until an intermediate condition Xᵢ is satisfied, at which point the intermediate stage 206 will cease and the cooking stage 208 will begin. The controller 80 can continue alternating between the intermediate stage 206 and cooking stage 208 accordingly until the cooking operation 200 is ceased.

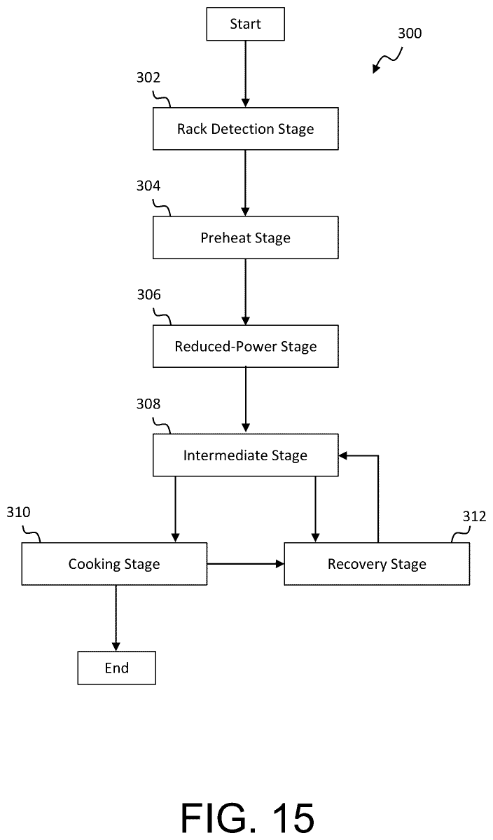

The cooking stage 208 of the high-heat cooking operation 200 described above is configured to temporarily operate the broil element 50 at a reduced-power scheme so that the cooking stone 106 has sufficient time to conductively heat the bottom portion of the food item before the upper portion is overcooked by the combination of convective heat from the air and radiative heat from the broil element 50. However, in some examples, residual heat in the air and broil element 50 may still cause the upper portion to cook faster than the bottom portion, even while the broil element 50 is de-energized. Thus, described below is a second high-heat cooking operation 300 (see FIG. 15) that is designed to de-energize the broil element 50 before its cooking stage begins, in order to reduce residual heat in the air and broil element 50 before the food item is placed in the oven cavity 18.

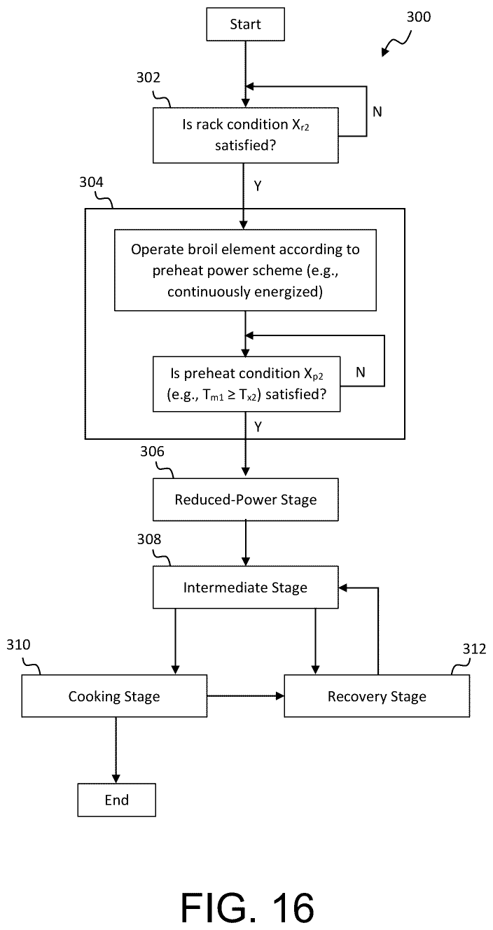

The high-heat cooking operation 300 comprises a rack detection stage 302, a preheat stage 304, a reduced-power stage 306, an intermediate stage 308, a cooking stage 310, and a recovery stage 312. The details of these stages are described below and illustrated further in FIGS. 16-21. Similar to the first cooking operation 200 described above, the second cooking operation 300 will activate only the broil element 50 to heat the oven cavity 18, without activating any other heating element or fan. Moreover, during the cooking operation 300, the rack assembly 100, 100′ will preferably be mounted in the oven cavity 18 close to the broil element 50, such that the cooking stone 106 is spaced about 8 inches or less below the broil element 50, and more preferably 6 inches or less below the broil element 50.

A user can initiate the second cooking operation 300 by entering a start command on the user interface 30, which in turn will provide a start signal to the controller 80 that causes it to start performing the rack detection stage 302. As shown in FIG. 16, the rack detection stage 302 will monitor the output of the rack detection device 188 to determine if a rack condition Xᵣ₂ is satisfied in which the rack assembly 100, 100′ is present within the oven cavity 18. If the output indicates that the rack condition Xᵣ₂ is satisfied (i.e., the rack assembly 100, 100′ is present), the controller 80 will proceed to and perform the preheat stage 304. Conversely, if the output indicates that the rack condition Xᵣ₂ is not satisfied (i.e., no rack assembly 100, 100′ is present), the controller 80 can either cease the cooking operation 300 or continue monitoring the output until it indicates that a rack assembly 100, 100′ is present.

The controller 80 will perform the preheat stage 304 (see FIG. 16) in response to completion of the rack detection stage 302 (which corresponds to the moment the rack condition Xᵣ₂ is satisfied). Preferably, the preheat stage 304 will be performed without any food being present in the oven cavity 18. During the preheat stage 304, the controller 80 will operate the broil element 50 according to a preheat power scheme until a preheat condition Xₚ₂ is satisfied, at which point the preheat stage 304 will cease and the reduced-power stage 306 will begin.

The preheat power scheme in the present embodiment continuously energizes the broil element 50 at full power for the entire preheat stage 304 until the preheat condition Xₚ₂ is satisfied. The preheat condition Xₚ₂ can be any condition that is predetermined to render the oven cavity 18 and/or cooking stone 106 sufficiently preheated for the cooking operation 300. In particular, the preheat condition Xₚ₂ can be based on a predetermined temperature threshold and/or amount of time. For example, the preheat condition Xₚ₂ in the present embodiment corresponds to a condition in which the temperature Tₘ₁ measured by the sensor 190 of the cooking stone 106 is equal to or greater than a predetermined target temperature Tₓ₂. For cooking fresh pizza, the target temperature Tₓ₂ will preferably be 700° F. or greater, and more preferably 750° F. or greater. In other examples, the preheat condition Xₚ₂ may correspond to a condition in which the broil element 50 has been operated according to the preheat power scheme for a predetermined amount of time (e.g., 30 minutes or more, and more preferably 24 minutes or more) sufficient to heat the cooking stone 106 up to a desirable temperature for the cooking operation.

The preheat stage 304 will thus operate the broil element 50 according to a preheat power scheme that heats the cooking stone 106 and the air within the upper portion 18a of the oven cavity 18 up to a high temperature (e.g., 700° F.). However, once a food item is placed on the cooking stone 106 and the cooking begins, keeping the broil element 50 energized throughout the cooking process may cause an upper portion of the food item to cook faster than the bottom, since the combination of convective heat from the air and radiative heat from the broil element 50 will be greater than the conductive heat from the cooking stone 106. This may cause the upper and lower portions of the food item to cook differently, resulting in the upper portion being overcooked and/or the lower portion being undercooked. Moreover, even if the broil element 50 is de-energized at the start of cooking, residual heat in the air and broil element 50 may still cause the upper portion to cook faster than the bottom portion.

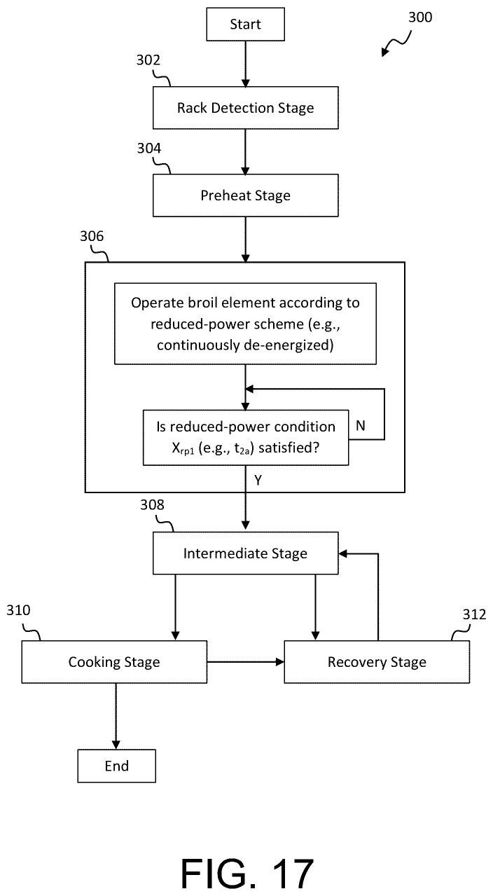

Accordingly, in the second cooking operation 300, the controller 80 will perform a first reduced-power stage 306 (see FIG. 17) in response to completion of the preheat stage 304 (which corresponds to the moment the preheat condition Xₚ is satisfied). The reduced-power stage 306 will operate the broil element 50 according to a reduced-power scheme in order to reduce a heat output of the broil element 50 before food is placed in the cavity 18. For instance, in the present embodiment, the reduced-power scheme will continuously de-energize the broil element 50 for the entire reduced-power stage 306. Thus, the reduced-power scheme will operate the broil element 50 at less power than the preheat-power scheme of the preheat stage 204.

Operating the broil element 50 at the reduced-power scheme (e.g., continuously de-energized) will cause the cavity temperature and the heat output of the broil element 50 to decrease (although the broil element 50 may still provide some heat output if, for example, it has residual heat and/or remains energized at a low level). Meanwhile, the cooking stone 106 will emit residual heat such that its heat output also decreases over time, but at a much slower rate than the combined heat output of the broil element 50 and cavity air. Thus, the reduced-power stage 306 can reduce heat output of the broil element 50 and cavity air while still maintaining a sufficiently high heat output for the cooking stone 106.

The reduced-power stage 306 will operate the broil element 50 according to the reduced-power scheme until a reduced-power condition Xₚ₁ is satisfied, at which point the reduced-power stage 306 will cease and the controller 80 will proceed to the intermediate stage 208. The reduced-power condition Xₚ₁ can be any predetermined condition in which the heat output of the broil element 50 and/or temperature of the cavity air has been sufficiently reduced for the cooking operation 300. In particular, the reduced-power condition Xₚ₁ can be based on a predetermined temperature threshold and/or amount of time. For example, the reduced-power condition Xₚ₁ in the present embodiment corresponds to a condition in which the broil element 50 has been operated according to the reduced-power scheme for a predetermined amount of time t₂ₐ (e.g., one minute). In other examples, the reduced-power condition Xᵣₚ₁ can correspond to a condition in which an air temperature measured by the auxiliary temperature sensor 184 of the appliance 10 is equal to or less than a predetermined target temperature.

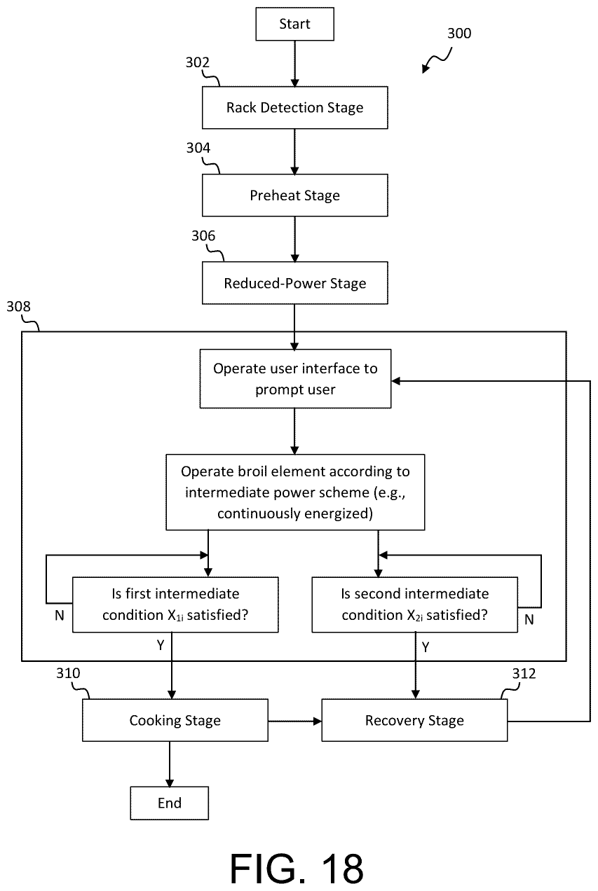

The controller 80 will perform the intermediate stage 308 in response to completion of the reduced-power stage 306 (which corresponds to the moment the reduced-power condition Xᵣₚ₁ is satisfied). At the beginning of the intermediate stage 308 (see FIG. 18), the controller 80 will operate the user interface 30 of the cooking appliance 10 to provide an indication that prompts a user to place a food item in the cavity 18. In particular, the controller 80 will provide an electrical signal to the user interface 30, which in turn will provide an output (e.g., light, image, sound, etc.) indicating (e.g., either explicitly or implicitly) that the reduced-power stage 306 is complete and a food item can be placed in the oven cavity 18.

Moreover, during the intermediate stage 308, the controller 80 will operate the broil element 50 according to an intermediate power scheme in order to keep the upper portion 18a of the oven cavity 18 and the cooking stone 106 heated while the user places a food item on the cooking stone 106 in the oven cavity 18. For example, the controller 80 can operate the broil element 50 based on a predetermined target temperature in order to achieve and/or maintain an oven cavity temperature about the target temperature. More specifically, the controller 80 can monitor an air temperature measured by the auxiliary temperature sensor 184 of the appliance 10, and then operate (e.g., energize, de-energize, cycle, etc.) the broil element 50 based on the measured temperature and a closed-loop control algorithm (e.g., hysteresis, PID control, etc.) such that the measured air temperature maintains about the target temperature Tₓ. However, in other examples, the controller 60 may simply operate the broil element 50 according to a fixed power scheme (e.g., continuously energized or cycled) with open loop control.

The controller 80 will operate the broil element 50 according to the intermediate power scheme for the entire intermediate stage 308 until either one of a first intermediate condition Xii and a second intermediate condition X₂ᵢ is satisfied, at which point the intermediate stage 308 will cease.

The first intermediate condition X₁ᵢ can be any predetermined condition indicating or suggesting that food has been placed in the cavity 18 and is ready for the cooking stage 310. For example, when a user opens the door 22 to insert a food item and then subsequently closes the door 22, the door sensor 84 can provide an input signal to the controller 80 indicating that the door 22 has been opened and closed during the intermediate stage 308. That input signal therefore suggests that a food item is in the cavity 18 and ready for cooking. Additionally or alternatively, the user can provide an input to the user interface 30 indicating that a food item is in the cavity 18 and ready for cooking, and the user interface 30 will provide a corresponding input signal to the controller 80 in response to the user input. Thus, the first intermediate condition X₁ᵢ can correspond to a condition in which the controller 80 receives either of those input signals from the door sensor 84 and user interface 30. In response to the first intermediate condition Xii, the controller 80 will cease the intermediate stage 308 and perform the cooking stage 310 (described further below).

If the first intermediate condition X₁ᵢ does not occur within a sufficient amount of time and the controller 80 continues to operate the broil element 50 according to the intermediate power scheme for an extended period of time, it is possible that the temperature of the cooking stone 106 will eventually drop to a temperature that is insufficient for high-heat cooking. Accordingly, the second intermediate condition X₂ᵢ can correspond to a condition in which the broil element 50 has been operated according to the intermediate power scheme for an undesirable length of time. For example, the second intermediate condition X₂ᵢ in the present embodiment corresponds to a condition in which the broil element 50 has been operated according to the intermediate-power scheme for a predetermined amount of time (e.g., 5 minutes). In other examples, the second intermediate condition X₂ᵢ can correspond to a condition in which the temperature Tₘ₁ measured by the temperature sensor 190 of the cooking stone 106 is equal to or less than a predetermined target temperature.

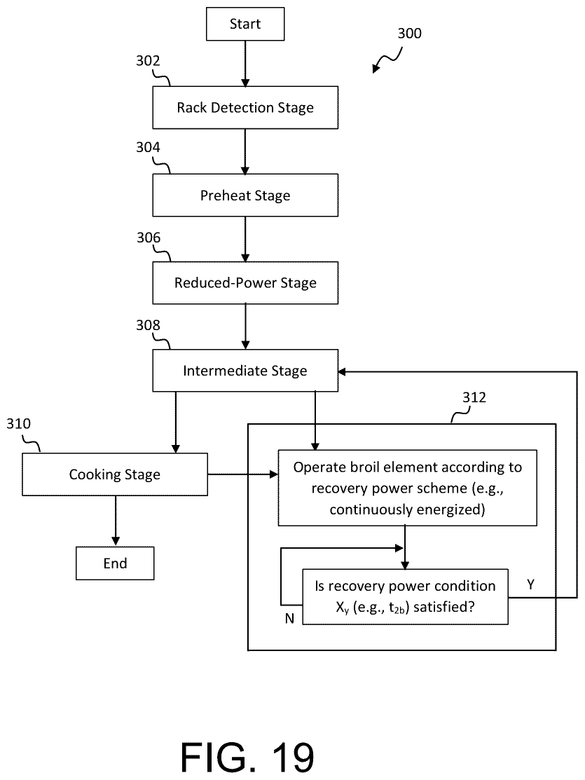

In response to the second intermediate condition X₂ᵢ being satisfied, the controller 80 will cease the intermediate stage 308 and perform the recovery stage 312 (see FIG. 19). In that stage 312, the controller 80 will operate the broil element 50 according to a recovery power scheme until a recovery condition X_{y} is satisfied, at which point the recovery stage 312 will cease and the reduced-power stage 306 will restart.

The recovery power scheme in the present embodiment continuously energizes the broil element 50 at full power for the entire recovery stage 312 until the recovery condition X_{y} is satisfied. The recovery condition X_{y} can be any condition that is predetermined to render the cooking stone 106 sufficiently recovered for the cooking operation 300. In particular, the recovery condition X_{y} can be based on a predetermined temperature threshold and/or amount of time. For example, the recovery condition X_{y} in the present embodiment corresponds to a condition in which the broil element 50 has been operated according to the recovery power scheme for a predetermined amount of time t_{2b} (e.g., 3-5 minutes) sufficient to reheat the cooking stone 106 up to a desirable temperature for the cooking operation 300. In other examples, the recovery condition X_{y} can correspond to a condition in which the temperature Tₘ₁ measured by the sensor 190 of the cooking stone 106 is equal to or greater than a predetermined target temperature.

The controller 80 will repeat the intermediate stage 308 in response to completion of the recovery stage 312 (which corresponds to the moment the recovery condition X_{y} is satisfied). If the second intermediate condition X₂ᵢ occurs again during operation of the intermediate stage 308, the controller 80 will keep cycling through recovery and intermediate stages 312, 308 until the first intermediate condition X₁ᵢ is eventually satisfied during the intermediate stage 308, at which point the controller 80 will cease the intermediate stage 308 and perform the cooking stage 310.

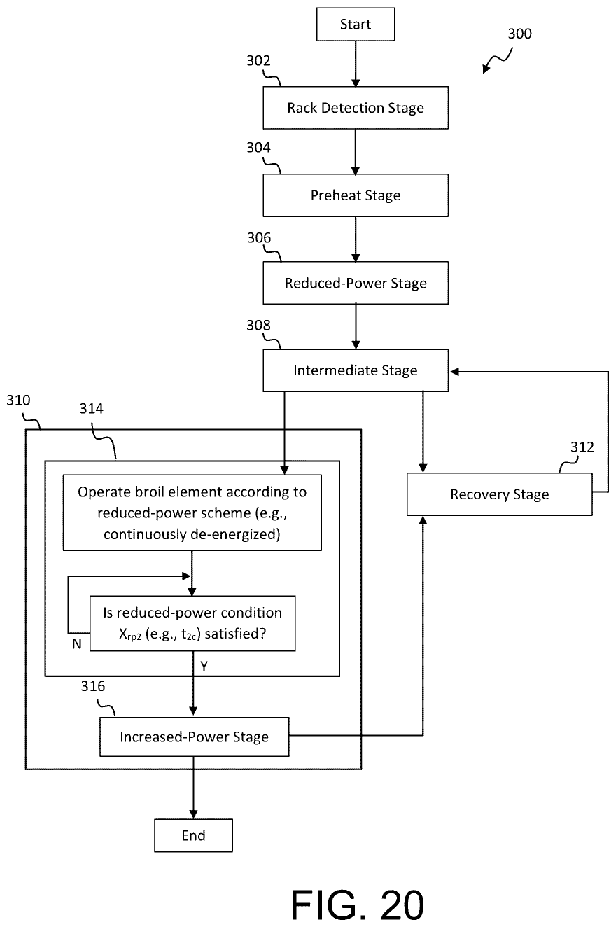

In response to the first intermediate condition Xii being satisfied, the controller 80 will cease the intermediate stage 308 and perform the cooking stage 310 (see FIG. 20). At the beginning of the cooking stage 310, the controller 80 will perform another reduced-power stage 314 that operates the broil element 50 according to a reduced-power scheme in order to reduce or limit a heat output of the broil element 50 during the beginning of the cooking stage 310. In particular, the reduced-power scheme will continuously de-energize the broil element 50 for the entire reduced-power stage 314. Thus, the reduced-power scheme will operate the broil element 50 at less power than the power schemes of the preheat, intermediate, and recovery stages 304, 308, 312 described above.

Operating the broil element 50 at the reduced-power scheme (e.g., continuously de-energized) will cause air temperature and the heat output of the broil element 50 to decrease. Meanwhile, the cooking stone 106 will emit residual heat to conductively cook the food item resting thereon. Thus, the reduced-power stage 314 can begin cooking the lower portion of the food item while the cavity and broil element 50 are providing relatively low heat output to the upper portion of the food item.

The reduced-power stage 314 will operate the broil element 50 according to the reduced-power scheme until a reduced-power condition Xᵣₚ₂ is satisfied, at which point the reduced-power stage 314 will cease and the controller 80 will proceed to an increased-power stage 316. The reduced-power condition Xᵣₚ₂ can be any predetermined condition in which the lower portion of the food item has been at least partially cooked and the upper portion of the food item is ready for additional heat to complete the cooking process. In particular, the reduced-power condition Xᵣₚ₂ can be based on a predetermined temperature threshold and/or amount of time. For example, the reduced-power condition Xᵣₚ₂ in the present embodiment corresponds to a condition in which the broil element 50 has been operated according to the reduced-power scheme for a predetermined amount of time t_{2c} (e.g., one minute). In other examples, the reduced-power condition Xᵣₚ₂ can correspond to a condition in which a temperature measured by the auxiliary temperature sensor 184 of the appliance 10 is equal to or less than a predetermined target temperature.

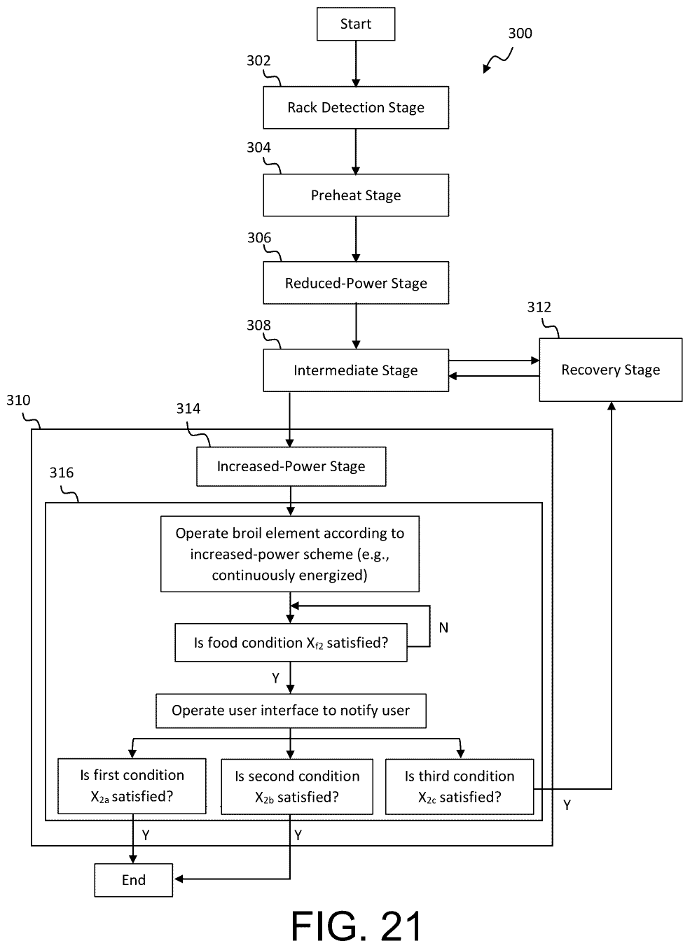

The controller 80 will perform the increased-power stage 316 (see FIG. 21) in response to completion of the reduced-power stage 310 (which corresponds to the moment the reduced-power condition Xᵣₚ₂ is satisfied). In this stage 316, the controller 80 will operate the broil element 50 according to an increased-power scheme in order to increase a heat output of the broil element 50 and finish cooking the food item at high heat. In particular, the increased-power scheme will continuously energize the broil element 50 at full power for the entire increased-power stage 316. Thus, the increased-power scheme will operate the broil element 50 at greater power than the reduced-power scheme.

During the increased-power stage 316, the controller 80 can operate the user interface 30 to provide a notification to the user once the food item is finished cooking. In particular, the controller 80 can determine if a food condition X_{f2} is satisfied indicating or suggesting that the food item is finished cooking. The food condition X_{f2} can be based on a predetermined temperature threshold and/or amount of time. For example, the food condition X_{f2} in the present embodiment corresponds to a condition in which the broil element 50 has been operated according to the increased-power scheme for a predetermined amount of time (e.g., one minute) sufficient to finish cooking the food item. In other examples, the food condition X_{f2} can correspond to a condition in which a temperature measured by a food probe is equal to or greater than a predetermined target temperature. In response to the food condition X_{f2} being satisfied, the controller 80 will provide an electrical signal to the user interface 30, which in turn will provide an output (e.g., light, image, sound, etc.) indicating (e.g., either explicitly or implicitly) that the food item can be removed from the cavity 18.

The increased-power stage 316 will continue operating the broil element 50 according to the increased-power scheme until either one of a first condition X₂ₐ, a second condition X_{2b}, and a third condition X₂c is satisfied, at which point the increased-power stage 316 will cease. For example, the first condition X₂ₐ may correspond to a condition in which the controller 80 receives an input signal to cancel the cooking operation 300. More specifically, a user can enter a cancel command on the user interface 30, which in turn will provide a corresponding input signal to the controller 80. If this first condition X₂ₐ is satisfied, the controller 80 will cease the whole cooking operation 300. In other words, the first condition X_{2b} enables a user to manually end the cooking operation 300.

Meanwhile, the second condition X_{2b} may correspond to a condition in which a predetermined amount of time (e.g., 5 minutes) has lapsed since the food condition X_{f2} was initially satisfied. If that second condition X_{2b} is satisfied, the controller 80 will also cease the whole cooking operation 300. In other words, the second condition X_{2b} enables the controller 80 to automatically cease the cooking operation 300 if no cancel command is provided by the user within the predetermined amount of time.

Lastly, the third condition X₂c may correspond to a condition in which the controller 80 receives an input signal to repeat the cooking operation 300. More specifically, if a user wants to cook another food item using the cooking operation 300, the user can enter a repeat command on the user interface 30, which in turn will provide a corresponding input signal to the controller 80. If this third condition X₂c is satisfied, the controller 80 will cease the increased-power stage 316 and begin the recovery stage 312 in response to completion of the increased-power stage 316. As discussed above, the controller 80 will perform the intermediate stage 308 in response to completion of the recovery stage 312, and then perform the cooking stage 310 if the first intermediate condition Xᵢ, is satisfied during the cooking stage 310. The controller 80 can continue cycling through the recovery, intermediate, and cooking stages 312, 308, 310 accordingly until the cooking operation 300 is ceased.

The rack assemblies 100, 100′ and high-heat cooking operations 200, 300 described above can achieve a relatively high temperature (e.g., 750° F.) for cooking food items without heating the oven cavity 18 at-large up to a temperature that exceeds safety regulations and requires the oven door 22 to automatically lock. In particular, the assemblies 100, 100′ and cooking operations 200, 300 can be particularly useful for cooking food items such a fresh pizza or steak, which can benefit from high cooking temperatures.

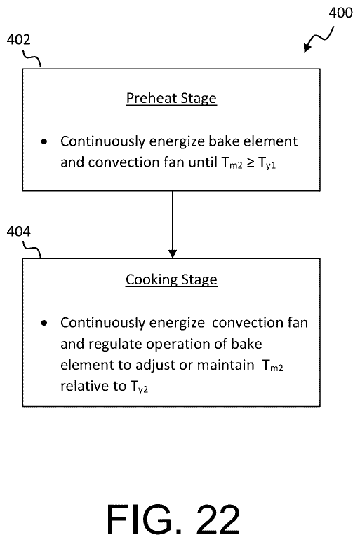

Turning to FIG. 22, a third cooking operation 400 will now be described for cooking frozen pizza or other (typically frozen) food items. The cooking operation 400 includes a preheat stage 402 and a cooking stage 404, and can be performed using any type of rack assembly mounted within the oven cavity. The rack assembly preferably will be mounted at a central elevation within the oven cavity 18, although lower and higher elevations are possible in some embodiments.

A user can initiate the second cooking operation 400 by entering a start command on the user interface 30, which in turn will provide a start signal to the controller 80 that causes it to start performing the preheat stage 402. Preferably, the preheat stage 402 will be performed without any food being present in the oven cavity 18. During the stage 402, the controller 80 will continuously energize the bake element 40 and convection fan 64 until a temperature Tₘ₂ measured by the oven cavity sensor 82 is equal to or greater than a predetermined target temperature T_{y1}, at which point the preheat stage 402 will cease and the cooking stage 404 will commence. Moreover, upon completion of the preheat stage 402, the controller 80 will provide an electrical signal to the user interface 30, which in turn will provide an output (e.g., light, image, sound, etc.) indicating (e.g., either explicitly or implicitly) that the preheat stage 402 is complete and a food item can be placed in the oven cavity 18. In other words, as in the prior embodiment the aforementioned output will trigger insertion of the food to be cooked by the user.

During the cooking stage 404, the controller 80 will continuously energize the convection fan 64 while regulating operation of the bake element 40 to adjust or maintain the measured temperature Tₘ₂ relative to a predetermined target temperature T_{y2}. That is, the controller 80 will cycle the bake element 40 on and off based on a predetermined control algorithm (e.g., using PID or hysteresis control) to adjust or maintain the measured temperature Tₘ₂ such that it is close to the target temperature T_{y2}. Preferably, once the measured temperature Tₘ₂ reaches the target temperature T_{y2}, the cooking stage 404 will maintain the measured temperature Tₘ₂ within 15° F. of the target temperature T_{y2}, and more preferably within 10° F. of the target temperature T_{y2}. In other words, the measured temperature Tₘ₂ will fluctuate between peaks of high and low temperatures that are within 15° F. of the target temperature T_{y}2 or less, preferably for the entire cooking stage 404; e.g., those peaks being the hysteresis bounds of the algorithm that controls the bake element 40 to maintain the target temperature close to the target temperature T_{y2}.

In some examples, the target temperatures T_{y1}, T_{y2} of the preheat and cooking stages 402, 404 can correspond to a desired cooking temperature Td (e.g., 350° F.) that is selected on the user interface 30 and input to the controller 80, such that the preheat stage 402 increases the measured temperature Tₘ₂ up to the desired cooking temperature Td and the cooking stage 404 maintains the measured temperature Tₘ about that temperature. In other examples, one or both of the target temperatures T_{y1}, T_{y2} can be offset from the desired temperature Td by a predetermined offset to account for inaccuracies, inefficiencies, thermal inertias, sensor locations, or other conditions associated with the cooking appliance 10.

In some examples, the cooking stage 404 can continue energizing the convection fan 64 and regulating operation of the bake element 40 in the manner described above indefinitely until the user cancels the cooking operation 400 by providing a cancel command on the user interface 30, which in turn will provide a corresponding signal to the controller 80. In other words, the cooking stage 404 will continue indefinitely until the controller 80 receives a cancel signal from the user interface 30. In other examples, the cooking stage 404 can continue energizing the convection fan 64 and regulating operation of the bake element 40 for a predetermined amount of time that is either programmed into the controller 80 or set by a user on the user interface 30.

By utilizing the convection fan 64 and bake element 40 as described above, the second cooking operation 400 can evenly thaw and cook a frozen pizza or other frozen food items. However, it is to be appreciated that various modifications can be made to the cooking operation 400 without departing from the scope of the disclosure. Broadly speaking, the cooking operation 400 can comprise any operation having a preheat stage that energizes the convection fan 64 and a heating element until the measured temperature Tₘ₂ reaches a predetermined target temperature, and a cooking stage that energizes the convection fan 64 and regulates operation of a heating element to maintain the measured temperature Tₘ₂ relative to a predetermined target temperature.

Illustrative embodiments have been described, hereinabove. It will be apparent to those skilled in the art that the above apparatuses and methods may incorporate changes and modifications without departing from the general scope of this disclosure. The disclosure is intended to include all such modifications and alterations disclosed herein or ascertainable herefrom by persons of ordinary skill in the art without undue experimentation.

What is claimed is:

1. A rack assembly that is mountable within an oven cavity of a cooking appliance, the rack assembly comprising:
a cooking stone;
an insulating mat defining a recess configured to accommodate the cooking stone; and
a rack configured to support the insulating mat,
wherein a superficial area of the insulating mat is at least 70% of a superficial area of the rack.

2. The rack assembly according to claim 1, wherein the insulating mat inhibits lateral movement of the cooking stone when accommodated within the recess.

3. The rack assembly according to claim 1, wherein:
the rack comprises a plurality of wires that extend within a primary plane, and
the insulating mat includes a bottom wall configured to support the cooking stone when accommodated within the recess, wherein a distance between the bottom wall and the primary plane is 1 to 6 inches.

4. The rack assembly according to claim 1, wherein the rack inhibits lateral movement of the insulating mat and the cooking stone in first and second opposing directions relative to the rack.

5. The rack assembly according to claim 1, wherein:
the insulating mat comprises a receiving portion that defines the recess, and
the rack defines a well configured to accommodate the receiving portion when the insulating mat rests of the rack, the well having dimensions complementary to dimensions of the recess portion of said insulating mat.

6. The rack assembly according to claim 1, wherein the insulating mat comprises a single metal sheet that defines the recess.

7. The rack assembly according to claim 1, wherein the cooking stone comprises a solid body and a temperature sensor affixed to or embedded within the solid body.

8. A cooking operation for a cooking appliance that includes a oven cavity, a broil element adjacent to an upper wall of the oven cavity, a rack within the oven cavity, and a cooking stone supported by the rack, the cooking operation comprising:
a preheat stage during which the broil element is operated according to a preheat-power scheme in order to heat the cooking stone and air within the oven cavity;
a reduced-power stage during which the broil element is operated according to a reduced-power scheme in order to reduce a heat output of the broil element while the cooking stone emits residual heat, wherein the reduced-power scheme operates the broil element at less power than the preheat-power scheme; and
an increased-power stage during which the broil element is operated according to an increased-power scheme, wherein the increased-power scheme operates the broil element at greater power than the reduced-power scheme.

9. The cooking operation according to claim 8, wherein:
the broil element is continuously energized for the entire preheat stage,
the broil element is continuously de-energized for the entire reduced-power stage, and
the broil element is continuously energized for the entire increased-power stage.

10. The cooking operation according to claim 8, wherein:
the preheat stage operates the broil element according to the preheat-power scheme until a preheat condition is satisfied,
the reduced-power stage operates the broil element according to the reduced-power scheme until a reduced-power condition is satisfied, and
the preheat condition and the reduced-power condition are each based on an associated predetermined temperature threshold or an associated predetermined amount of time.

11. The cooking operation according to claim 8, wherein the increased-power stage operates the broil element according to the increased-power scheme until an increased-power condition is satisfied, wherein the increased-power condition is based on:
a predetermined amount of time, or
an input signal from a user interface of the cooking appliance.

12. The cooking operation according to claim 8, wherein:
the increased-power stage operates the broil element according to the increased-power scheme until either one of a first condition and a second condition is satisfied,
the first condition is based on a predetermined amount of time or predetermined temperature threshold, and
the second condition is based on an input signal from a user interface of the cooking appliance.

13. The cooking operation according to claim 8, further comprising an intermediate stage that is performed in response to completion of the preheat stage, wherein the intermediate stage includes:
operating a user interface of the cooking appliance to provide an output that prompts a user to place a food item in the oven cavity, and
operating the broil element according to an intermediate power scheme until an intermediate condition is satisfied, wherein the intermediate condition is based on an input signal from a user interface of the cooking appliance, or an input signal from a door sensor of the cooking appliance.

14. The cooking operation according to claim 13, wherein the reduced-power stage is performed in response to completion of the intermediate stage, and the increased-power stage is performed in response to completion of the reduced-power stage.

15. The cooking operation according to claim 14, wherein the intermediate stage is repeated in response to completion of the increased-power stage.

16. The cooking operation according to claim 8, further comprising an intermediate stage that is performed in response to completion of the reduced-power stage, wherein the intermediate stage includes:
operating a user interface of the cooking appliance to provide an output that prompts a user to place a food item in the oven cavity, and
operating the broil element according to an intermediate power scheme until an intermediate condition is satisfied, wherein the intermediate condition is based on a predetermined amount of time, a predetermined threshold temperature, an input signal from a user interface of the cooking appliance, or an input signal from a door sensor of the cooking appliance.

17. The cooking operation according to claim 8, further comprising an intermediate stage that is performed in response to completion of the reduced-power stage, wherein the intermediate stage includes:
operating a user interface of the cooking appliance to provide an indication that prompts a user to place a food item in the oven cavity, and
operating the broil element according to an intermediate power scheme until either one of a first condition and a second condition is satisfied,
wherein the first condition is based on an input signal from a user interface of the cooking appliance or an input signal from a door sensor of the cooking appliance, and
wherein the second condition is based on a predetermined amount of time or a predetermined threshold temperature.

18. The cooking operation according to claim 17, wherein the cooking operation includes:
a cooking stage that is performed in response to the first condition, wherein cooking stage includes the increased-power stage, and
a recovery stage that is performed in response to either one of the second condition and completion of the cooking stage, wherein the recovery stage includes operating the broil element according to a recovery power scheme until a recovery condition is satisfied, wherein the recovery condition is based on a predetermined amount of time or a predetermined threshold temperature.

19. The cooking operation according to claim 18, wherein the intermediate stage is repeated in response to completion of the recovery stage.

20. The cooking operation according to claim 8, further comprising a rack detection stage that determines if a rack condition is satisfied, wherein the preheat stage is performed in response to the rack condition being satisfied.
